(19) United States
(12) Patent Application Publication
(10) Pub. No.: US 2014/0013757 A1
(43) Pub. Date: Jan. 16, 2014

(54) Solar Thermal Gas Turbine System

(71) Applicants: Toru Eguchi, Tokyo (JP); Kazuhito Koyama, Tokyo (JP); Shigeo Hatamiya, Tokyo (JP); Fumio Takahashi, Tokyo (JP); Naoyuki Nagafuchi, Tokyo (JP); Yukinori Katagiri, Tokyo (JP)

(72) Inventors: Toru Eguchi, Tokyo (JP); Kazuhito Koyama, Tokyo (JP); Shigeo Hatamiya, Tokyo (JP); Fumio Takahashi, Tokyo (JP); Naoyuki Nagafuchi, Tokyo (JP); Yukinori Katagiri, Tokyo (JP)

(73) Assignee: Hitachi, Ltd., Chiyoda-ku, Tokyo (JP)

(21) Appl. No.: 14/002,286

(22) PCT Filed: Mar. 7, 2011
(86) PCT No.: PCT/JP2011/001304

§ 371 Date: Oct. 2, 2013

(51) Int. Cl. F02C 7/141; F03G 6/00

(52) U.S. Cl. CPC F02C 7/141; F03G 6/005
USPC 60/728; 60/641.8

(57) ABSTRACT

An object of the present invention is to provide a solar thermal gas turbine system enhanced in resistance to effects of disturbances including weather conditions in a gas turbine which sprays water into intake air of a compressor.

A solar thermal gas turbine system according to an aspect of the present invention includes the following: a gas turbine 200 including a compressor for compressing air, a combustor for burning a fuel and the air compressed by the compressor, and a turbine driven by a combustion gas generated by the combustor; a heat collector 130 for collecting solar heat; a heat accumulator 140 for reserving high-pressure hot water generated from the solar heat collected by the heat collector; a water atomization device 170 for spraying the high-pressure hot water into the air taken in by the compressor; an intercooler 180 for mixing the high-pressure hot water into the compressed air extracted from the compressor, as cooling air for the turbine; and an evaporator 190 for supplying steam, a product obtained with the high-pressure hot water used as a heat source, to the combustor.

### TECHNICAL FIELD

The present invention relates to a solar thermal gas turbine system configured to allow high-pressure hot water generated by utilizing solar energy to suppress a decrease in power generation by a gas turbine power generator system during temperature rise in atmospheric air.

### BACKGROUND ART

A gas turbine generator plant uses a fossil fuel such as natural gas or petroleum. Such a gas turbine generator plant is one example of power generator plants that supply industrial electric power. Since the gas turbine generator plant uses a fossil fuel, the plant is required to minimize emissions of carbon dioxide (CO₂), one of global warming substances. At the same time, the gas turbine generator plant is known to have a characteristic in that under the conditions that atmospheric temperature rises as in the summer, the amount of air taken into compressors will decrease and the generator will accordingly decrease in output power with the decrease in the amount of air intake. In the summer, in particular, while an increase in demand for cooling will call for generating the largest possible amount of electricity, emissions of CO₂ will increase if fuel is oversupplied in an attempt to meet the demand.

For a gas turbine generator system, even under the condition that electric power demand increases in the summer season, currently being desired with the above technical background in mind are a system intended to achieve highly efficient and high-output plant operation and to suppress an increase in CO₂ emissions, and a method of operating the system.

Patent Documents 1 and 2, for example, describe techniques relating to spraying water into intake air of a gas turbine compressor. Patent Document 1, which relates to the gas turbine generator system of a regenerative cycle scheme that enhances power-generating efficiency using a highly humid working medium, discloses the technique serving as means of suppressing a decrease in output due to an increase in atmospheric air temperature. The technique disclosed in Patent Document 1 is used to generate high-pressure hot water from a source of heat, such as compressed air from the compressor outlet and/or exhaust gases from the gas turbine, and then utilize boiling under reduced pressure to spray the thus-obtained high-pressure hot water into the air taken into the compressor. Patent Document 2 discloses the technique for adding, under a flash-atomized state, hot water that has been obtained by heating with gas turbine exhaust gases, to a gaseous substance present at an induction port to the compressor.

In addition, the techniques described in Patent Documents 3 and 4, for example, are known as the art for applying solar heat to a gas turbine. Patent Document 3 concerns using a solar thermal heating system to heat a fuel supplied to a combustion system of a turbomachine. Patent Document 4, which concerns a solar thermal power generator system that uses liquid air, discloses the technique for heating high-pressure liquid air to around normal temperature by means of a regenerative heat exchanger with turbine-emitted, further heating the heated air to high-temperature by means of a solar heat concentrator, and then driving the turbine with the high-temperature high-pressure air obtained.

### PRIOR ART LITERATURE

### Patent Documents

Patent Document 1: JP-2001-214757-A
Patent Document 2: JP-2002-519558-A
Patent Document 3: JP-2010-144725-A
Patent Document 4: JP-1996-189457-A

### SUMMARY OF THE INVENTION

### Problems to be Solved by the Invention

In foregoing Patent Documents 1 and 2, it is only disclosed that the heat that has occurred within the cycle (i.e., the thermal energy that the compressed air, the gas turbine exhaust gases, and the like possess) is used as the energy source for reducing sprayed water to very fine particles, and no consideration is given to applying the solar heat.

In foregoing Patent Documents 3 and 4, on the other hand, it is disclosed that the solar heat is applied to the respective gas turbine systems. However, it is generally not easy to operate and manage efficiently the natural energy affected by disturbances including weather conditions. Desired, therefore, is means of optimizing the operation and management of exhaust gases, natural energy, and other diverse sources of heat, according to disturbance-causing conditions.

An object of the present invention is to provide a solar thermal gas turbine system enhanced in resistance to effects of disturbances including weather conditions in a gas turbine which sprays water into intake air of a compressor.

### Means for Solving the Problem

An aspect of the present invention includes the following: a gas turbine including a compressor for compressing air, a combustor for burning a fuel and the air compressed by the compressor, and a turbine driven by a combustion gas generated by the combustor; a heat collector for collecting solar heat; a heat accumulator for reserving high-pressure hot water generated from the solar heat collected by the heat collector; a water atomization device for spraying the high-pressure hot water into the air taken in by the compressor; an intercooler for mixing the high-pressure hot water into the compressed air extracted from the compressor, as cooling air for the turbine; and an evaporator for supplying steam, a product obtained with the high-pressure hot water used as a heat source, to the combustor.

### Effects of the Invention

The present invention allows provision of a solar thermal gas turbine system that is enhanced in resistance to effects of disturbances including weather conditions in the gas turbine which sprays water into intake air of the compressor.

### BRIEF DESCRIPTION OF THE DRAWINGS

FIG. 1 is a block diagram of a solar thermal gas turbine system and its control apparatus according to a first embodiment;

FIG. 2 is a schematic diagram representing a flow of energy in the gas turbine system of the first embodiment;

FIG. 3 is a flowchart showing an operation sequence of the gas turbine system and control apparatus according to the first embodiment;

FIG. 4 is a flowchart showing an operation sequence of optimal manipulation command calculation in the control apparatus of the first embodiment;

FIG. 5 shows an example of screen specifications for setting execution conditions and an operation mode by use of a maintenance tool of the first embodiment;

FIG. 6 shows an example of screen specifications relating to process value display by the maintenance tool of the first embodiment;

FIG. 7 shows an example of screen specifications relating to system evaluation value display by the maintenance tool of the first embodiment;

FIG. 8 is a block diagram of a solar thermal gas turbine system and its control apparatus according to a second embodiment; and

FIG. 9 is a schematic diagram representing a flow of energy in the gas turbine system of the second embodiment.

### MODE FOR CARRYING OUT THE INVENTION

Embodiments of a solar thermal gas turbine system and its control apparatus according to the present invention will be next described referring to the accompanying drawings.

### First Embodiment

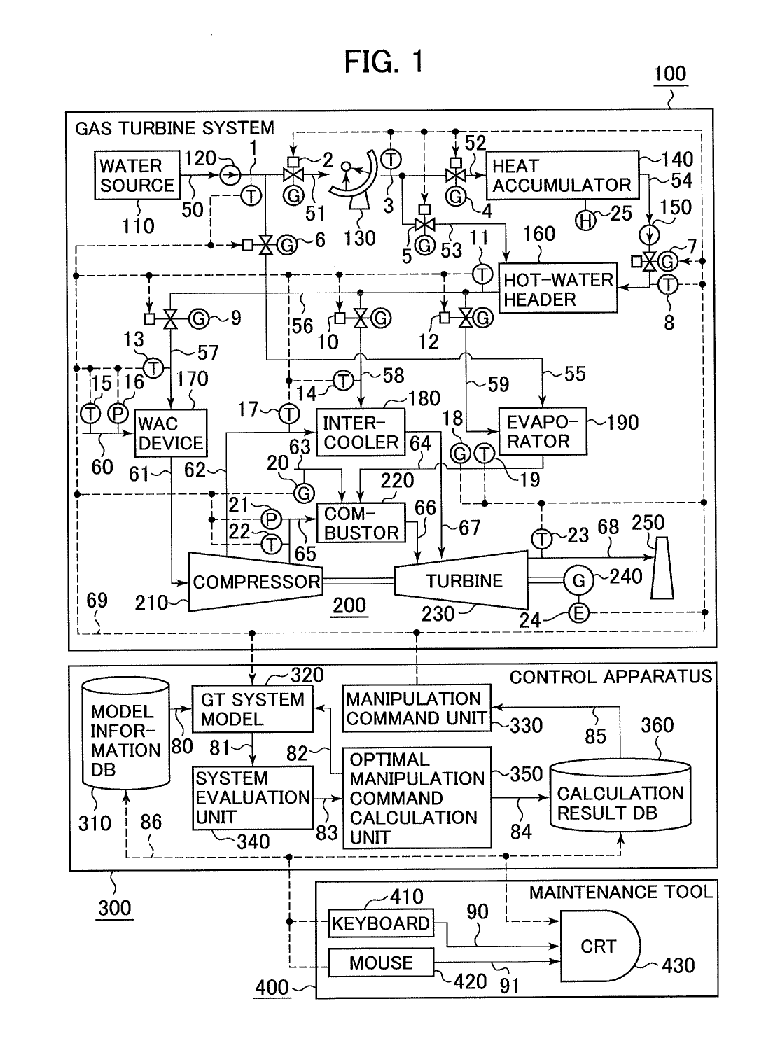

A first embodiment of the present invention is described below using FIG. 1. FIG. 1 shows a block diagram of a solar thermal gas turbine system and its control apparatus, the gas turbine system being equipped with a high-temperature water atomization cooling (WAC) device that applies solar heat to the gas turbine generator system, with an intercooler for cooling the turbine, and with an evaporator.

The gas turbine system 100 in FIG. 1 is first described below. Referring to FIG. 1, a water source 110 in the gas turbine system 100 keeps a stock of normal-temperature water 50 to be supplied to the system, and a feed water pump 120 supplies the water as normal-temperature water 51 and normal-temperature water 55 to a heat collector 130 and an evaporator 190, respectively. The heat collector 130 has a function that acquires energy of solar light as heat, whereby the water that has been supplied to the heat collector 130 is heated to high temperature. Then, the heated water is supplied as high-temperature water 52 and high-temperature water 53 to a heat accumulator 140 and a hot-water header 160, respectively. The heat accumulator 140 has a function that reserves an excess of the heat which the heat collector 130 has acquired, and the thus-reserved heat is guided as high-temperature water 54 into the hot-water header 160 via the feed water pump 150 when necessary. The hot-water header 160 has a function that temporarily stores the high-temperature water flows 53 and 54 thereinto as high-temperature water 56, and the high-temperature water 56 stored within the header 160 is supplied to the WAC device 170, the intercooler 180, and the evaporator 190, via independent lines (high-temperature water lines 57 to 59).

The gas turbine 200 includes, as its main constituent elements, a compressor 210 that compresses air 60, a combustor 220 that burns a fuel 63 and compressed air, the air 60 as compressed by the compressor 210, and a turbine 230 driven by a combustion gas 66 that the combustor 220 has generated. An electric power generator 240 is connected to the turbine 230 via a shaft, and is driven by rotation of the turbine 230. The air 60 of atmospheric conditions is supplied to the WAC device 170 installed at an inlet side of the compressor 210 in the thus-constructed gas turbine 200, and upon atomization of the high-temperature water 57 inside the WAC device 170, the air 60 is guided into the compressor 210 as highly humid air 61. Before inducting liquid droplets into the compressor 210, the WAC device 170 vaporizes a part of atomized liquid droplets, and after inducting the liquid droplets and the air together into the compressor 210, the WAC device vaporizes unvaporized liquid droplets while the droplets flow downward through the compressor 210. Under the conditions that atmospheric temperature rises as in the summer, air density decreases and a flow rate of the air supplied to the compressor 210, correspondingly decreases, which in turn reduces turbine output. Accordingly the WAC device, by taking in air and atomizing hot water into this air as discussed earlier herein, can use latent heat of evaporation of the hot water to reduce an air temperature of the compressor inlet and hence to compensate for the reduction in turbine output.

After being pressurized inside the compressor 210, the highly humid air 61 flows into the combustor 220 as the compressed air 65. The combustor 220 burns the compressed air 65 and the fuel 63, thus generating the hot combustion gas 66. The combustion gas 66 flows into the turbine 230, rotates the turbine 230 and the generator 240 connected thereto via the shaft, and causes the generator to generate electricity. The combustion gas 66 that has driven the turbine 230 is released from a stack 250 into the atmosphere as a combustion exhaust gas 68.

In addition, part of the compressed air which the compressor 210 has generated flows into the intercooler 180 as compressed air 62, and after the high-pressure hot water 58 supplied thereto from the hot-water header 160 has been sprayed, the compressed air 62 flows as cooling air 67 into a high-pressure section of the turbine 230 that is to be cooled. Since the intercooler 180 is provided, the compressed air 62 that has been extracted by the compressor 210 becomes the highly humid cooling air 67, which further improves cooling performance. This improvement reduces the flow rate of the compressed air 62 extracted from the compressor 210, and hence raises fuel efficiency and turbine output.

The evaporator 190 generates high-temperature steam 64 by conducting a heat exchange of normal-temperature water 55 with the high-pressure hot water 59 supplied from the hot-water header 160, and guides the steam 64 to the combustor 220. The combustor 220 lowers a temperature of a section which locally becomes hot as a result of steam spraying, and thereby provides an effect of suppressing an occurrence of nitrogen oxides (NOₓ) and other environmentally burdening substances, associated with combustion, and an effect of enhancing output due to the steam acting as a working fluid for the turbine.

In the gas turbine system 100 of FIG. 1, feed water temperature gauges 1, 3, 8, 11, 13, 14, feed water flowmeters/flow control valves 2, 4, 5, 6, 7, 9, 10, 12, a steam flowmeter 18, and a steam temperature gauge 19 are placed to measure and control feed water line process quantities. In addition, air temperature gauges 15, 17, 22, air pressure gauges 16, 21, a fuel flowmeter 20, and a gas temperature gauge 23 are placed to measure/control combustion air/gas line process quantities. Furthermore, a generator output gauge 24 and an accumulator gauge 25 are placed to measure respectively the amount of electrical energy output generated in the generator 240, and the amount of heat stored in the heat accumulator 140. The system, as with conventional gas turbine systems, further includes a valve to control a flow rate of the fuel, but the valve is emitted in FIG. 1.

The control apparatus 300 acquires measurement information 69 on-line from the above measuring instruments and uses the measurement information 69 to calculate and output a desirable manipulation command. The gas turbine system 100 operates the flow control valves 2, 4, 5, 6, 7, 9, 10, 12 on the basis of the manipulation command information (measurement information) 69 that has been output from the control apparatus 300, and executes plant control. The signal 69 here serves as both the manipulation command information and the measurement information.

Next, details of the control apparatus 300 in FIG. 1 are described below. The measurement information 69, after being acquired from the gas turbine system 100, is input to a gas turbine (GT) system model 320 and an optimal manipulation command calculation unit 350. The GT system model 320 has a function that simulates and calculates a behavior of the gas turbine system 100 on the basis of physical phenomena and value/statistical information. More specifically, the GT system model 320 simulates and calculates the behavior of the gas turbine system 100 on the basis of model information 80 stored in model information database (DB) 310, and manipulation command information 82 output from the optimal manipulation command calculation unit 350. This means that the manipulation command information 69, which is based upon the manipulation command information 82, is simulated to be applied to the gas turbine 100, resulting in the measurement information 69. The GT system model also has a function that uses the system-acquired measurement information 69 to conduct automatic corrections for the model to have characteristics closer to those of an actual machine. Model calculation information 81 that has thus been obtained by the above functions is output to a system evaluation unit 340.

The system evaluation unit 340 calculates operation efficiency η and generator output P_{w} of the plant with respect to the plant operational state given by the model calculation information 81. The operation efficiency η and generator output P_{w} of the plant are calculated using following expressions 1 and 2:

$$\begin{matrix}( Expression 1 ) & \\ η = \frac{Pw}{{G}_{Fuel} \cdot {H}_{Fuel}} & Expression 1 \\ ( Expression 2 ) & \\ {P}_{w} = {P}_{T} - {P}_{C} - {P}_{loss} & Expression 2\end{matrix}$$

Referring to expression 1, G_{Fuel} and H_{Fuel} denote the flow rate of the fuel and the amount of heat generated by the fuel, respectively, and these values are acquired as the measurement information and physical properties value relating to the plant. Referring to expression 2, P_{T}, P_{C}, and Pₗₒₛₛ denote turbine output, compressor output, and energy loss, respectively. The five values can all be derived using the measuring instrument information shown in FIG. 1, and the physical properties value.

The system evaluation information 83 including the calculated operation efficiency and generator output of the plant is output to the optimal manipulation command calculation unit 350, in which a manipulation command that maximizes the operation efficiency and generator output of the plant is searched for by optimization calculation based upon constraint conditions obtained from the model information 84 which the GT system model 320 outputs. The constraint conditions here include weather/atmospheric temperature conditions, an operation mode of the system, the amount of heat stored, and the like. Further detailed operation of the optimal manipulation command calculation unit 350 will be described later herein. Calculation result information 85 for optimization is stored in a calculation result database (DB) 360. A manipulation command unit 330 uses calculation result information 86 to generate optimal manipulation command information 69 and input this information 69 into the gas turbine 100, and based on this input, the flow control valves 2, 4, 5, 6, 7, 9, 10, 12 are operated.

Finally, details of the maintenance tool 400 in FIG. 1 are described below. The maintenance tool 400 displays screen input/output information 87, that is, the information stored in the model information DB 310 and calculation result DB 360 both included in the control apparatus 300, on a CRT device 430. A keyboard input 90 entered from a keyboard 410, and a mouse input 91 entered using a mouse 420 are also input to the control apparatus 300 as the screen input/output information 87. The constraint conditions relating to the optimizing calculation are included in screen input information.

The description of the block diagram of the solar thermal gas turbine system and control apparatus shown in FIG. 1 is now complete.

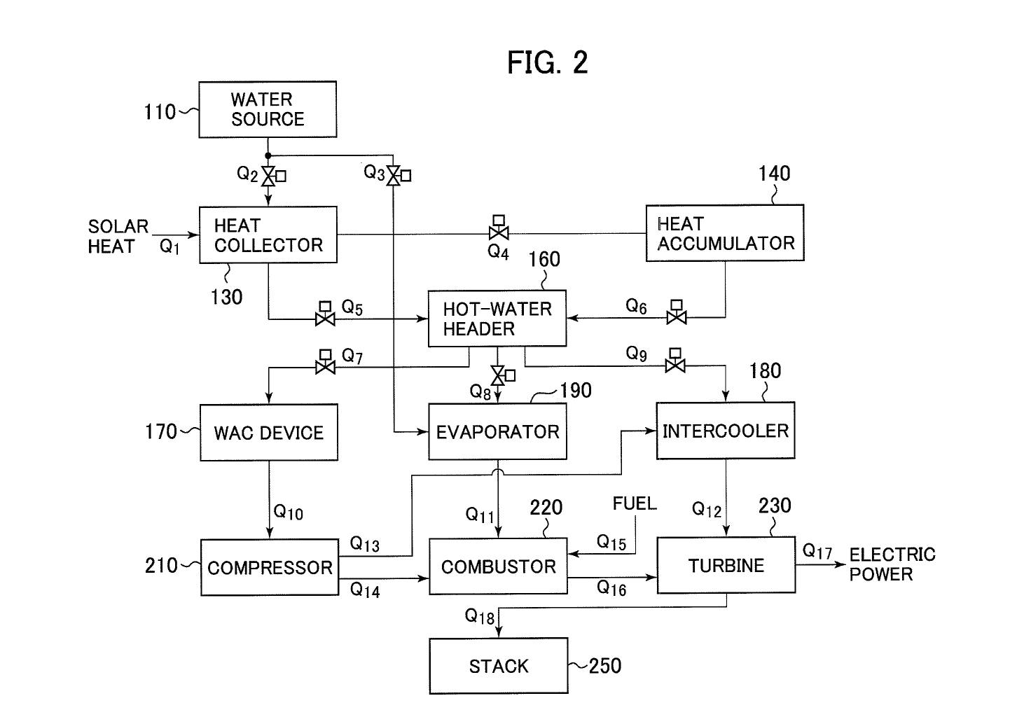

Next, purposes of control in the present embodiment are described in further detail below using FIG. 2 that shows a flow of energy between the constituent elements of the gas turbine system 100. Any losses of energy in the feed water and gas lines are ignored in FIG. 2. Referring to FIG. 2, the kinds of energy input to the system from external elements are solar heat energy Q₁, the amounts of heat Q₂ and Q₃ in the normal-temperature water from the water source, and fuel energy Q₁₅. The kinds of energy output to external elements are electrical energy Q₁₇ obtained during/by the generation of electric power, and exhaust gas energy Q₁₈ discharged from the stack. In addition, constraint conditions due to individual flow-rate conditions or due to the temperature and pressure conditions predetermined allowing for operability and safety of the system elements exist in the above kinds of energy flowing between the system elements. For example, a flow rate of the feed water guided from the water source 110 and a flow rate of the hot water which can be inducted into the hot-water header 160 from the heat accumulator 140 fall under a category of the constraint conditions. It should be noted that the control in the present embodiment is to determine allocations of the various kinds of energy, Q₂-Q₉ in FIG. 2, to ensure that while satisfying the constraint conditions, the system optimizes plant efficiency and plant output.

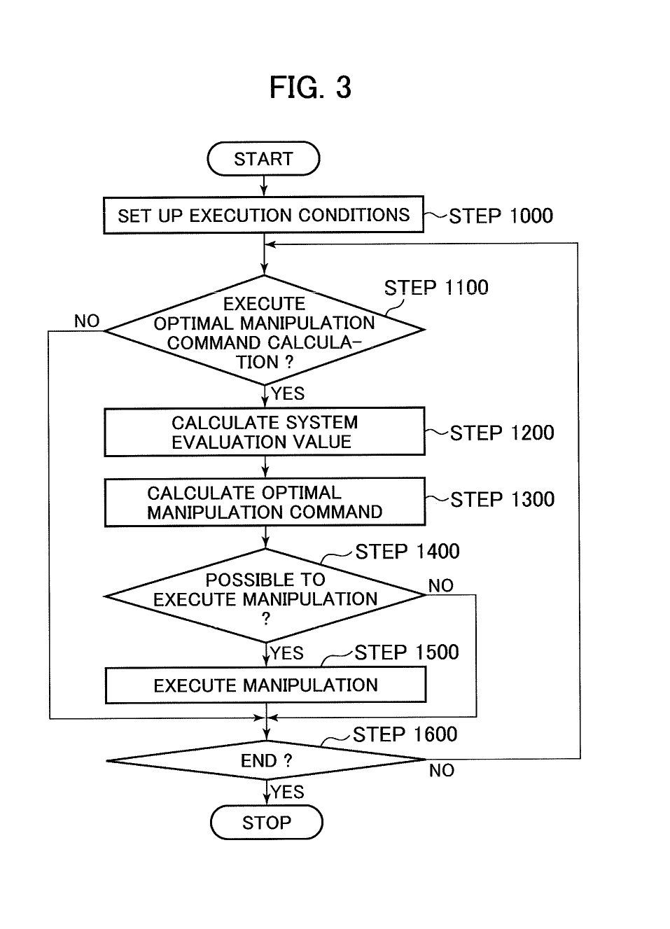

Next, detailed operation of the control apparatus 300 in FIG. 1 is described below using a flowchart of FIG. 3. FIG. 3 shows a sequence that includes steps 1000, 1100, 1200, 1300, 1400, 1500, and 1600.

Under the conditions that the gas turbine system 100 is working, execution conditions for the control apparatus 300 are set up in step 1000 after an operational startup of the control apparatus. In this step, an operation mode of the control, the constraint conditions relating to optimization, and threshold values for operation-executing determination are set up. Next step 1100 is branching, in which step, it is determined whether a condition for executing the optimal manipulation command calculation in the control apparatus 300 is satisfied. That is to say, after execution of an immediately previous optimal manipulation command calculation, whether a calculation execution internal time that was set in step 1000 has elapsed is determined and if so, process control advances to step 1200. If not so, control skips to step 1600. Alternatively, the optimizing calculation and the operation can be forcibly executed, independently of the above determination criterion.

In step 1200, a system evaluation value with respect to current plant operating conditions is calculated using the GT system model 320, the system evaluation unit 340, and the model information DB 310.

In step 1300, optimal manipulation command conditions allowing for the constraint conditions are calculated using the GT system model 320, the system evaluation unit 340, the model information DB 310, and the optimal manipulation command calculation unit 350.

Step 1400 is branching, in which step, a comparison is conducted between the system evaluation values that were calculated in steps 1200 and 1300 with respect to the current plant operating conditions, and the optimal manipulation command conditions that have been determined by the optimizing calculation. If execution of the determined manipulation command is likely to improve plant efficiency or generator output and an improvement ratio is equal to or greater than its threshold value that was set up in step 1000, control advances to step 1500. If the improvement ratio is smaller than the threshold value, control skips to step 1600.

In step 1500, the plant is operated in line with the manipulation command conditions that were determined in step 1300.

Step 1600 is branching, in which step, if a condition for terminating the operation of the control apparatus 300 by external input, for example, is satisfied, process control proceeds to a step for terminating the succession of operational steps, or if the condition is not satisfied, control is returned to step 1100.

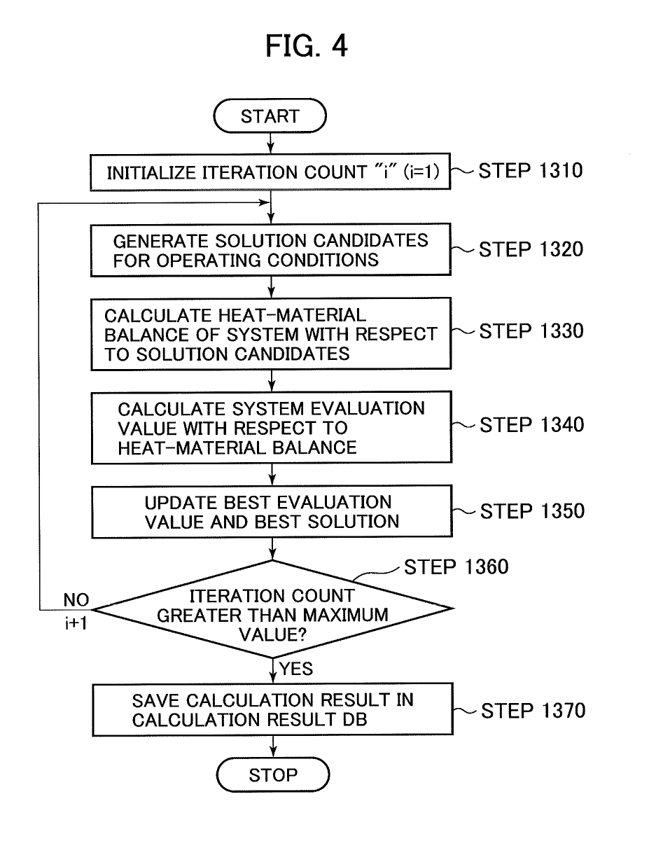

Next, detailed operation of the optimal manipulation command calculation unit 350, the GT system model 320, and the system evaluation unit 340 is described below using a flowchart of FIG. 4. FIG. 4 gives a detailed description of the operation in step 1300 of FIG. 3, this step being inclusive of steps 1310, 1320, 1330, 1340, 1350, 1360, 1370.

First, an iteration count “i” of the optimizing calculations is initialized to 1 in step 1310. Next, candidates for a combination of the operating conditions to be searched for are generated in step 1320. The operating conditions here mean the feed water flow conditions relating to a flow passageway on which the flow control valves in the gas turbine system 100 are placed. Hereinafter, the combination of operating conditions is called the solution. The generation of the solution candidates may use a known algorithm (genetic algorithm, simulated annealing, particle group optimizing, or the like) as an optimizing method.

Next, in step 1330, the measurement information obtained from the measuring instruments of the system when the GT system model is operated using the determined solution candidates is calculated as a heat-material balance, on a simulation basis. In step 1340, a system evaluation value on plant efficiency or generator output with respect to the calculated heat-material balance is calculated using the system evaluation unit 340.

Next, in step 1350, comparisons are conducted between the calculated latest system evaluation value, the best evaluation value ever obtained through evaluation of existing solution candidates, and the solution candidates (the best solution). Then, if the latest system evaluation value is appropriate and acceptable, the best evaluation value and the best solution are updated to the latest ones.

Next step 1360 is branching, in which step, if the iteration count “i” in above successive process steps 1320-1350 is equal to or greater than a maximum value that was set up in step 1000 of FIG. 3, control proceeds to step 1370. If “i” is less than the maximum value, 1 is added to “i” and then control is returned to step 1320. In other words, the optimal solution is obtained by iterating the successive process steps a fixed number of times.

In step 1370, the obtained best evaluation value and optimal solution are saved in the calculation result DB 360 and the successive process steps are terminated (control proceeds to step 1400 of FIG. 3).

In accordance with the solar thermal gas turbine system and its control apparatus having the above configuration and functions, the control apparatus can calculate the optimal manipulation command that satisfies the operation mode and the constraint conditions, at fixed time intervals according to not only the operational state obtained through the measurement information in the gas turbine system, but also the particular disturbance conditions such as weather conditions. As a result, plant efficiency and generator output can both be improved compared with the case where the present embodiment is not applied, and these improvements contribute to reduction in operating costs.

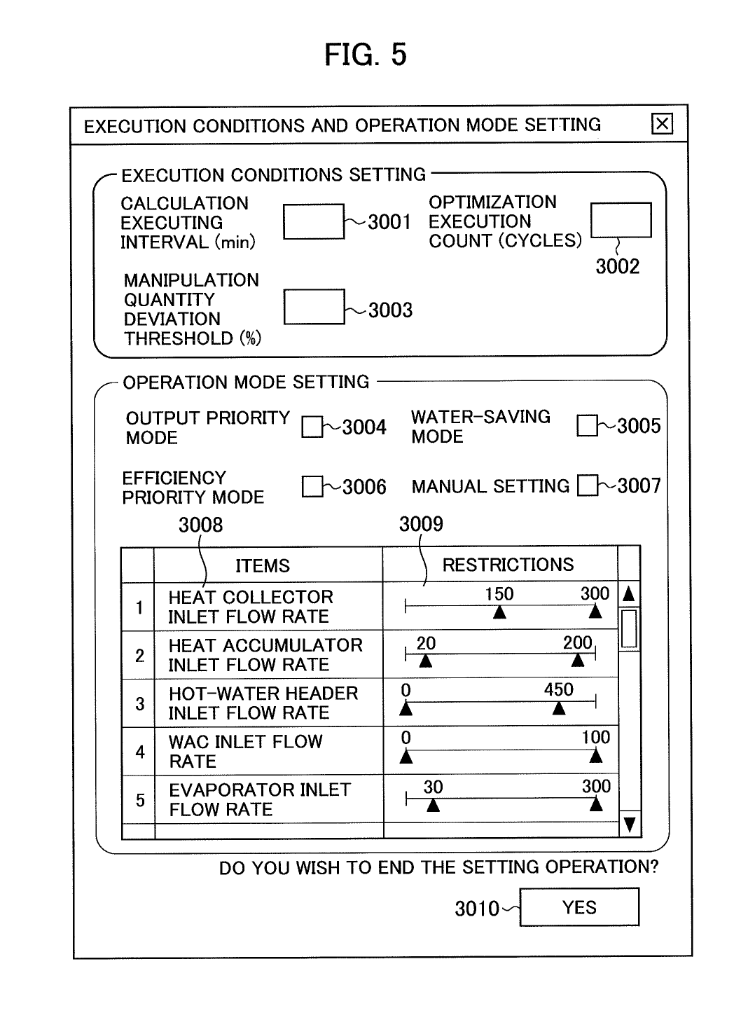

An example of screen specifications relating to the maintenance tool 400 in the present embodiment is next described below. FIG. 5 shows an example of a screen which the CRT device 430, part of the maintenance tool 400, displays when the execution conditions and operation mode to be used in the control apparatus 300 of the present embodiment are set. In the example of FIG. 5, an operator of the plant first moves the mouse to value boxes 3001, 3002, 3003 on the execution conditions setting screen. This allows the operator to enter/set the interval time for executing the optimizing calculation process, the number of optimizing calculations to be executed, and a deviation threshold value for operation executing determination. Next, an operation mode appropriate for particular operating needs can be selected by selecting any of check boxes 3004, 3005, 3006, 3007 using the mouse. An output priority mode, shown in FIG. 5, is an operation mode that determines a manipulation command for maximum generator output, a water-saving mode is an operation mode that saves water consumption, and an efficiency priority mode is an operation mode that determines a manipulation command for maximum plant efficiency. If any of the three operation modes is selected, restrictions (upper and lower limits of manipulation quantities) relating to corresponding manipulation quantities (feed water flow rates) in various sections are set to match preprogrammed value automatically. If manual setting is selected, however, the plant operator can set arbitrary restrictions for the manipulation quantities. More specifically, a black triangle-marked gauge on a restrictions setting bar 3009 corresponding to a manipulation quantity item 3008 displayed on a listing screen can be slid horizontally by use of the mouse 420, to set the upper and lower limits of manipulation quantities to fall in a desired range. Finally, clicking a button 3010 terminates setting and causes the control apparatus 300 to execute the optimizing calculation process in accordance with the entered conditions and determine the manipulation command conditions.

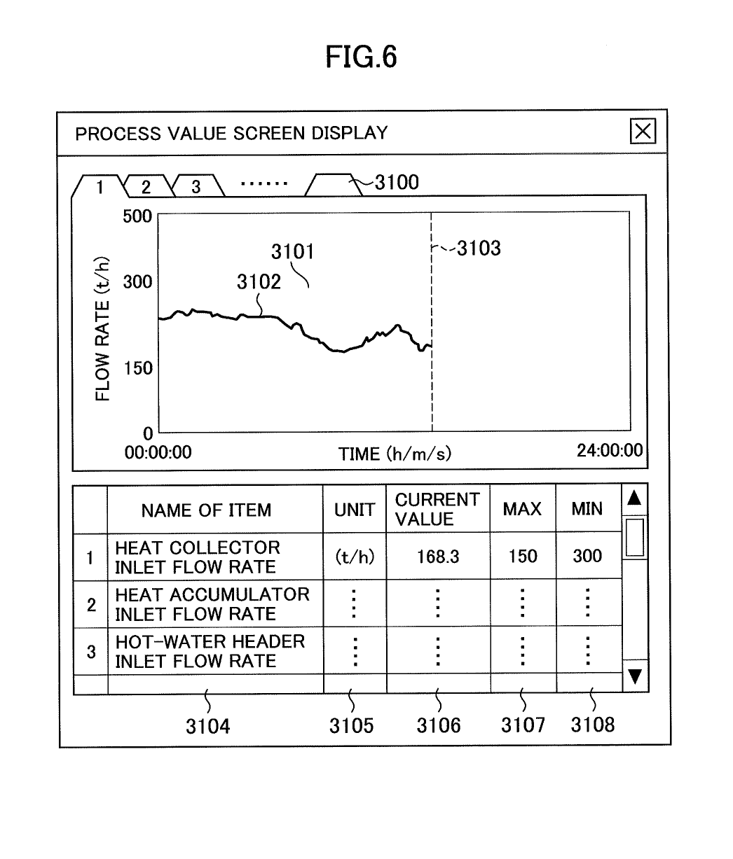

Next, FIG. 6 is described below. FIG. 6 shows an example of process value display screen specifications relating to the manipulation quantities displayed on the screen of the CRT device 430 during the operation of the control apparatus 300 and maintenance tool 400 in the present embodiment. Graphs of time-series changes in on-line acquired manipulation quantities are selectively displayed on an upper half of the screen, and status value on each manipulation quantity is listed on a lower half of the screen. Selection of a tag 3100 allows the graph display of a manipulation quantity to be switched to that of another manipulation quantity, in which case, time-series changes in the selected manipulation quantity (flow rate) are drawn as series 3102, with time plotted on a horizontal axis and the manipulation quantity on a vertical axis. A range 3101 of the entered restrictions is displayed in bar form on the graph, so that during continuous plant operation, the operator can confirm whether the process value about the manipulation quantity satisfies the restrictions. A dotted line 3103 is further displayed together to clearly indicate the current time. On the status screen, the manipulation quantity is displayed in an itemized format, with an item name 3104, a unit 3105, a current flowrate value 3106, an entered maximum value 3107, and an entered minimum value 3108. The operator, by checking these graphs against the status value or vice versa, can visually check whether the plant is being properly controlled according to the present embodiment.

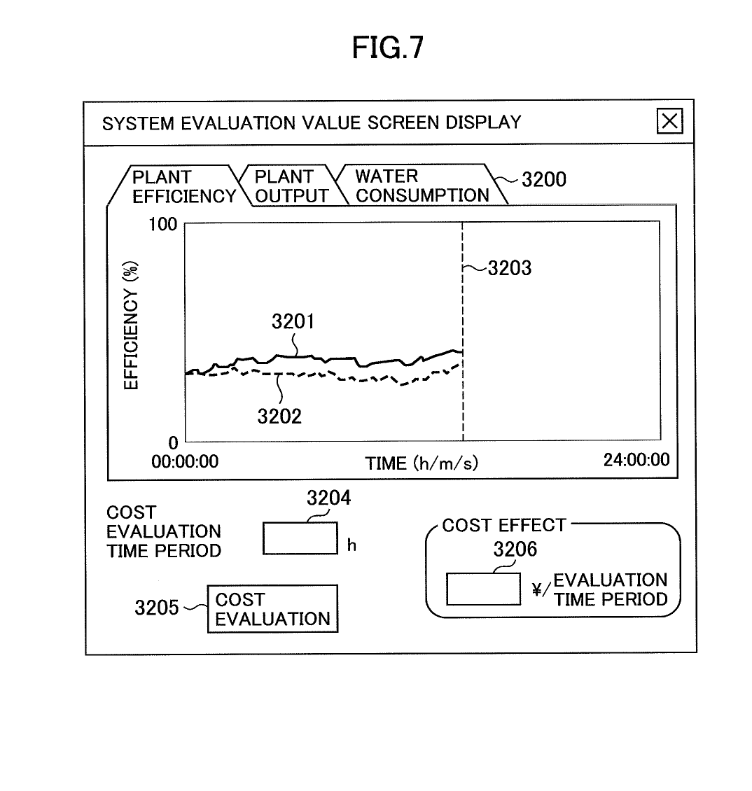

Finally, FIG. 7 is described below. FIG. 7 shows an example of display screen specifications relating to the system evaluation value displayed on the screen of the CRT device 430 during the operation of the control apparatus 300 and maintenance tool 400 in the present embodiment. On-line calculated/acquired time-series changes in plant efficiency, generator output, and water consumption, are selectively displayed in graph form as the system evaluation value. Selection of a tag 3200 allows the graph display of a desired evaluation value about the system to be switched to that of another evaluation value, in which case, time-series changes in the selected evaluation value are drawn as series 3201 with a solid line, time being plotted on a horizontal axis and the evaluation value on a vertical axis. On the graph, changes in evaluation value that will occur if it is assumed that the control apparatus in the present embodiment has not been applied so far during plant operation are also drawn as series 3202 with a dotted line, in overlapped form on series 3201. Thus, effects obtained by applying the control apparatus of the present embodiment can be visually checked by comparing both series. In addition, a dotted line 3203 is displayed together to clearly indicate the current time. Cost reduction effects yielded as a result of the application effects can be further displayed on this screen. Entering a cost evaluation time period using a value box 3204 and then clicking a button 3205 allows trial calculation of both the plant-operating costs assuming that the control apparatus in the present embodiment is applied in the entered cost evaluation time period effective retroactively from the current time, and the plant-operating costs assuming that the control apparatus is not applied in the entered cost evaluation time period. A difference in plant-operating costs between the two cases is also displayed in a cost effect display box 3206. This screen display allows the plant operator to confirm that the effects provided by applying the control apparatus of the present embodiment are displayed as the evaluation values about plant efficiency and other items, and as the cost effects in the definite period of time.

In accordance with the above embodiment, a solar thermal gas turbine system whose optimal operation intended to always achieve high efficiency and high output according to particular weather conditions and the like can be executed if a control apparatus determines appropriate operating conditions based on the measurement information supplied from constituent elements of the gas turbine system in which the high-pressure hot water and high-temperature high-pressure steam generated using solar heat are used for a water atomization device, an intercooler, and an evaporator.

### Second Embodiment

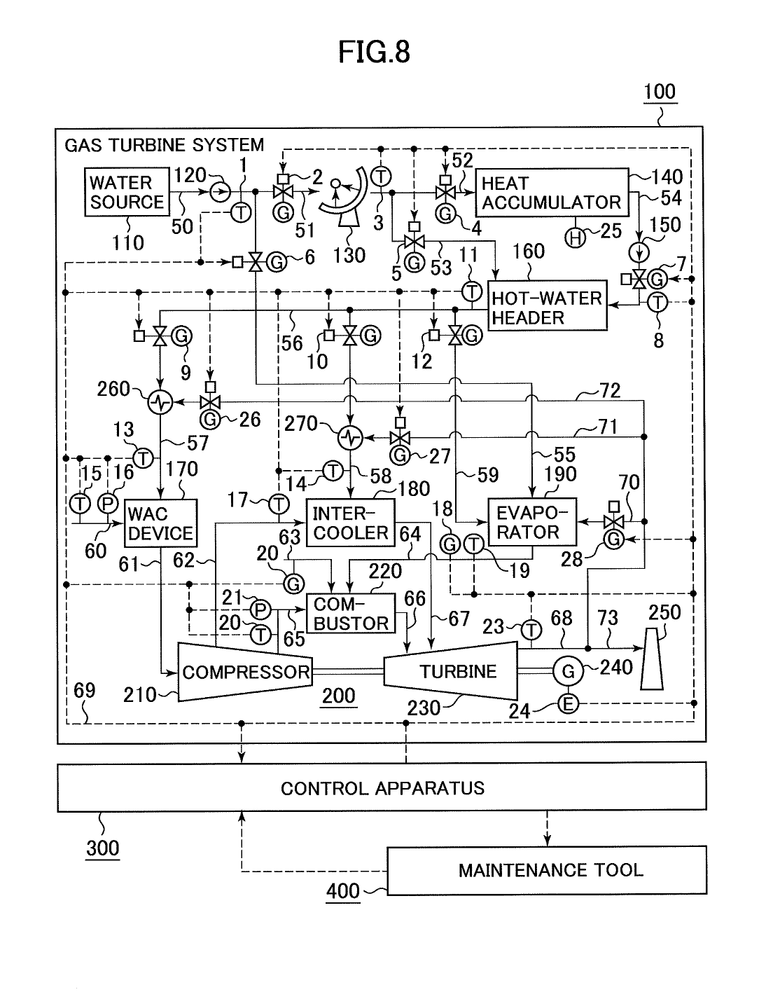

A second embodiment of the present invention is described below using FIG. 8. FIG. 8 is a block diagram of a solar thermal gas turbine system and its control apparatus, the gas turbine system being equipped with a high-temperature water atomization cooling (WAC) device that applies solar heat to the gas turbine generator system, with an intercooler for cooling the turbine, and with an evaporator. The gas turbine generator system further includes facilities that can compensate for a decrease in the amount of solar heat energy, or the source of heat, by circulating combustion exhaust gases of the gas turbine.

The following description focuses upon constituent elements different from those of the first embodiment, shown in FIG. 1. In addition to the elements shown in FIG. 1, the gas turbine system in FIG. 8 include an element that uses the evaporator 190 to conduct a heat exchange of the combustion exhaust gas 68 released from the turbine 230, and elements that use evaporators 260, 270 to conduct a heat exchange of combustion exhaust gases 71, 72, respectively. Exhaust gas flowmeters/flow control valves 26, 27, 28 are also added to measure/control the flow rates of the gas in various sections of the combustion exhaust gas line which supplies the combustion exhaust gases as an auxiliary source of heat to the evaporator 190 and the heat exchangers 260, 270. The above system configuration that circulates the combustion exhaust gases of the gas turbine allows waste heat to be used effectively, which is conducive to improvement of plant efficiency. Additionally, even if a sufficient amount of solar heat energy cannot be acquired under adverse weather conditions, operation free of a decrease in plant output can be executed by compensating for such a quantitative undersupply of the heat source.

The control apparatus 300 acquires on-line the measurement information 69 supplied from the measuring instruments shown in FIG. 8, inclusive of the above instruments, and uses the acquired information 69 to calculate and output a desirable manipulation command. The gas turbine system 100 operates the flow control valves 2, 4, 5, 6, 7, 9, 10, 12, 26, 27, 28 on the basis of the manipulation command information (measurement information) 73 that has been output from the control apparatus 300, and controls the plant. The signal 69 here serves as both the manipulation command information and the measurement information.

In accordance with the solar thermal gas turbine system and its control apparatus having the above configuration and functions, the control apparatus can calculate the optimal manipulation command that satisfies the operation mode and the constraint conditions, at fixed time intervals according to not only the operational state obtained through the measurement information in the gas turbine system, but also particular disturbance conditions such as weather conditions. As a result, plant efficiency and generator output can both be improved over those obtainable if the present embodiment is not applied, and these improvements contribute to reduction in operating costs.

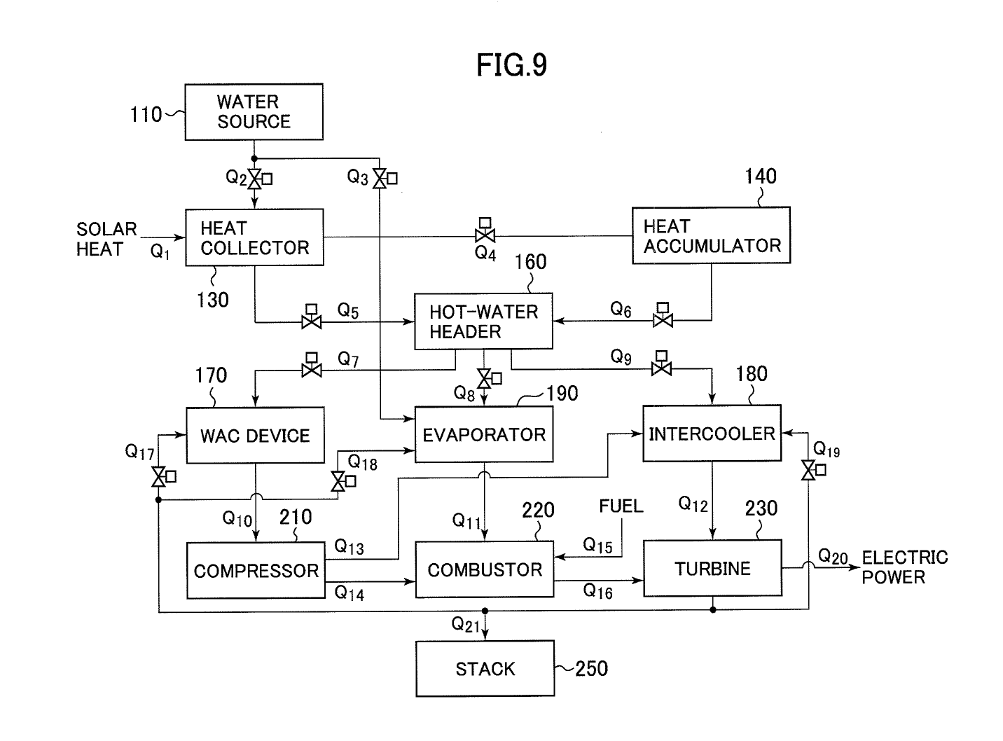

Next, purposes of control in the present embodiment are described in further detail below using FIG. 9 that shows a flow of energy between the constituent elements of the gas turbine system 100. In FIG. 9, any losses of energy in the feed water and gas lines are ignored, as in FIG. 2. Referring to FIG. 9, the kinds of energy input to the system from external elements are solar heat energy Q₁, the amounts of heat, Q₂ and Q₃, in the normal-temperature water from the water source, and fuel energy Q₁₅. The kinds of energy output to external elements are electrical energy Q₂₀ obtained during/by the generation of electric power, and exhaust gas energy Q₂₁ discharged from the stack. Part of Q₂₁ is cyclically used in the system as Q₁₇ to Q₁₉. In addition, constraint conditions depending upon individual flow-rate conditions and/or the like exist in the above kinds of energy flowing between the system elements. It should be noted that the control in the present embodiment is to determine allocations of the various kinds of energy, Q₂-Q₉ and Q₁₇-Q₁₉ in FIG. 2, to ensure that while satisfying the constraint conditions, the system optimizes plant efficiency and plant output.

### INDUSTRIAL APPLICABILITY

The present invention can be applied to solar thermal gas turbine systems.

### DESCRIPTION OF REFERENCE NUMERALS

100 Gas turbine system
110 Water source
120, 150 Feed water pumps
130 Heat collector
140 Heat accumulator
160 Hot-water header
170 Water atomization device
180 Intcrcooler
190 Evaporator
200 Gas turbine
210 Compressor
220 Combustor
230 Turbine
240 Electric power generator
250 Stack
260, 270 Heat exchangers
300 Control apparatus
310 Model information DB
320 GT system model
330 Manipulation command unit
340 System evaluation unit
350 Optimal manipulation command calculation unit
360 Calculation result DB
400 Maintenance tool
410 Keyboard
420 Mouse
430 CRT device

1. A solar thermal gas turbine system, comprising:
a gas turbine including a compressor for compressing air, a combustor for burning a fuel and the air compressed by the compressor, and a turbine driven by a combustion gas generated by the combustor;
a heat collector for collecting solar heat;
a heat accumulator for reserving high-pressure hot water generated from the solar heat collected by the heat collector;
a water atomization device for spraying the high-pressure hot water into the air taken in by the compressor;
an intercooler for mixing the high-pressure hot water into the compressed air extracted from the compressor, as cooling air for the turbine; and
an evaporator for supplying steam, a product obtained with the high-pressure hot water used as a heat source, to the combustor.

2. The solar thermal gas turbine system according to claim 1, further comprising a hot-water header for distributing the high-pressure hot water generated from the solar heat collected by the heat collector, or the high-pressure hot water reserved in the heat accumulator, to the water atomization device, the intercooler, and the evaporator.

3. The solar thermal gas turbine system according to claim 2, further comprising:
a measuring instruments for measuring a temperature and flow rate of feed water supplied to the heat collector, the heat accumulator, the water atomization device, the intercooler, the evaporator, and the hot-water header;
a valve for controlling the flow rate of the feed water; and
a control apparatus for generating a manipulation command for the control valve by use of measurement information acquired by the measuring instruments.

4. The solar thermal gas turbine system according to claim 3, wherein the control apparatus includes:
a gas turbine system model for calculating simulated system characteristics from the measurement information obtained by giving the desired manipulation command to the gas turbine system;
a system evaluation unit for calculating system efficiency and generator output by use of the information about the simulated gas turbine system characteristics that the gas turbine system calculates;
an optimal manipulation command calculation unit for deriving a manipulation command so that the efficiency and generator output calculated by the system evaluation unit will be optimal;
a model information database in which is stored a set of information including both execution conditions to be used in the gas turbine system model and the optimal manipulation command calculation unit, and restrictions on control; and
a calculation result database in which a result of the calculation by the optimal manipulation command calculation unit is stored.

5. The solar thermal gas turbine system according to claim 4, further comprising a maintenance tool having at least one of
a function for making a screen display of value stored in the model information database of the control apparatus, and
a function for displaying value stored in the calculation result database, and part of the measurement information obtained by the gas turbine system.

6. The solar thermal gas turbine system according to claim 1, further comprising
an exhaust gas line for supplying an exhaust gas of the gas turbine as a source of heat auxiliary to the high-pressure hot water supplied to the water atomization device, the intercooler, or the evaporator.

7. The solar thermal gas turbine system according to claim 6, further comprising:
a measuring instruments for measuring temperatures and flow rates of both
feed water supplied to the heat collector, the heat accumulator, the water atomization device, the intercooler, and the evaporator,
and the exhaust gas supplied by the exhaust gas line;
valves for controlling the flow rates of both the feed water and the exhaust gas; and
a control apparatus for generating manipulation commands for the control valves by use of measurement information acquired by the measuring instruments.
